(19) United States
(12) Patent Application Publication
(10) Pub. No.: US 2025/0332868 A1
(43) Pub. Date: Oct. 30, 2025

(54) TIRE

(71) Applicant: SUMITOMO RUBBER INDUSTRIES, LTD., Kobe-shi, Hyogo (JP)

(72) Inventor: Kensuke WASHIZU, Kobe-shi, Hyogo (JP)

(73) Assignee: SUMITOMO RUBBER INDUSTRIES, LTD., Kobe-shi, Hyogo (JP)

(21) Appl. No.: 18/724,489

(22) PCT Filed: Dec. 13, 2022
(86) PCT No.: PCT/JP2022/045924

§ 371 Date: Dec. 18, 2024

(30) Foreign Application Priority Data
Dec. 27, 2021 (JP) 2021-212685

(51) Int. Cl. B60C 11/00; B60C 1/00

(52) U.S. Cl. CPC B60C 11/005; B60C 1/0016; B60C 2011/0033

(57) ABSTRACT

Provided is a tire comprising a tread part having at least one rubber layer and a breaker, wherein a thickness of a cap rubber layer constituting a tread surface relative to a total thickness of the tread part is 20% or more, wherein an average value of acetone extraction amounts of a tread rubber constituting the tread part is 12.0% by mass or less, wherein a difference between the average value of the acetone extraction amounts of the tread rubber and an acetone extraction amount of a breaker topping rubber is 7.0% by mass or less, and wherein an average value of ash contents of the tread rubber is 7.5% by mass or more.

### TECHNICAL FIELD

The present invention relates to a tire.

### BACKGROUND ART

A hardening phenomenon due to change over time in a tread part of a tire has been a factor that causes a decrease in tire performance. Patent Document 1 describes, in a pneumatic tire having a tread part comprising a cap rubber layer, an intermediate rubber layer, and a base rubber layer, a hardening phenomenon of the tread part over time was effectively suppressed by setting a thickness of each rubber layer relative to a total thickness of the tread part and an acetone extraction amount of each rubber layer within predetermined ranges.

### PRIOR ART DOCUMENT

### Patent Document

Patent Document 1: JP 2005-67236 A

### SUMMARY OF THE INVENTION

### Problem to Be Solved by the Invention

It is an object of the present invention to provide a tire that suppresses a hardening phenomenon of a tread part over time and has improved steering stability and wet grip performance.

### Means to Solve the Problem

As a result of intensive studies, it was found that the above-described problems are solved by setting a thickness of a cap rubber layer relative to a total thickness of a tread part, an average value of acetone extraction amounts of a tread rubber, an acetone extraction amount of a breaker topping rubber, and an average value of ash contents of the tread rubber in predetermined relationships.

That is, the present invention relates to a tire comprising a tread part having at least one rubber layer and a breaker, wherein a thickness of a cap rubber layer constituting a tread surface relative to a total thickness of the tread part is 20% or more, wherein an average value of acetone extraction amounts of a tread rubber constituting the tread part is 12.0% by mass or less, wherein a difference between the average value of the acetone extraction amounts of the tread rubber and an acetone extraction amount of a breaker topping rubber is 7.0% by mass or less, and wherein an average value of the ash contents of the tread rubber is 7.5% by mass or more.

### EFFECT OF THE INVENTION

According to the present invention, provided is a tire that suppresses a hardening phenomenon of a tread part over time and has improved steering stability and wet grip performance.

### BRIEF DESCRIPTION OF THE DRAWINGS

FIG. 1 is a cross-sectional view showing a part of a tread of a tire relating to one embodiment of the present invention.

### EMBODIMENT FOR CARRYING OUT THE INVENTION

The tire that is one embodiment of the present invention is a tire comprising a tread part having at least one rubber layer and a breaker, wherein a thickness of a cap rubber layer constituting a tread surface relative to a total thickness of the tread part is 20% or more, wherein an average value of acetone extraction amounts of a tread rubber constituting the tread part is 12.0% by mass or less, wherein a difference between the average value of the acetone extraction amounts of the tread rubber and an acetone extraction amount of a breaker topping rubber is 7.0% by mass or less, and wherein an average value of the ash contents of the tread rubber is 7.5% by mass or more.

When the thickness of the cap rubber layer relative to the total thickness of the tread part, the average value of the acetone extraction amounts of the tread rubber, the acetone extraction amount of the breaker topping rubber, and the average value of the ash contents of the tread rubber satisfy the above-described requirements, a tire to be obtained suppresses a hardening phenomenon of the tread part over time and improves in steering stability and wet grip performance. A reason for that is not intended to be bound by any theory, but is considered as follows.

One of factors of change in tire hardness is that a concentration gradient of a plasticizer between a tread part and a tire internal member causes the plasticizer to migrate from a tread rubber to an internal rubber, resulting in a decrease in an amount of the plasticizer in the tread rubber, particularly in a cap rubber. In the tire of the present invention, (1) by setting the average value of the acetone extraction amounts of the tread rubber and the acetone extraction amount of the breaker topping rubber within the above-described ranges, diffusion of the plasticizer from the tread rubber to the breaker topping rubber can be appropriately controlled. From this, the present invention has features that a change in hardness of a rubber layer on a tread surface due to use of the tire can be appropriately controlled and that (2) migration of the plasticizer can be suppressed by setting the average value of the ash contents of the tread rubber within the above-described range. Then, it is considered that, by cooperation of these features, a remarkable effect of suppressing a hardening phenomenon of the tread rubber over time to significantly improve steering stability and wet grip performance is achieved.

A Shore hardness (Hs) of the cap rubber layer is preferably 55 or more and 70 or less. Moreover, a rate of change in Shore hardness (Hs) of the cap rubber layer after being left to stand at 80° C. for two months is preferably −10% or more and 10% or less.

It is considered that steering stability and wet grip performance can be maintained by setting the Shore hardness of the cap rubber layer within the above-described range.

A rubber composition constituting the cap rubber layer preferably comprises 5 parts by mass or more and 100 parts by mass or less of a plasticizer based on 100 parts by mass of a rubber component. The plasticizer preferably comprise at least one selected from the group consisting of oil, an ester-based plasticizer, a resin component, and a liquid polymer, more preferably comprises at least one selected from the group consisting of a resin component and a liquid polymer, and further preferably uses at least one selected from the group consisting of oil and an ester-based plasticizer in combination with at least one selected from the group consisting of a resin component and a liquid polymer. A mass content ratio of the resin component and the liquid polymer to the oil and the ester-based plasticizer in the rubber composition constituting the cap rubber layer is preferably 0.5 or more and 20 or less.

It is considered that the plasticizer can be suppressed from migrating to an adjacent rubber layer at an early stage to cause the rubber to harden by compounding the plasticizer in the rubber composition constituting the cap rubber layer in the above-described aspect.

A tan δ of the cap rubber layer at 30° C. is preferably 0.30 or less.

When the tan δ of the cap rubber layer is 0.30 or less, heat generation during running is reduced, so that it is considered that hardening of a first layer over time is suppressed.

0° C. E* of the cap rubber layer is preferably 4.0 MPa or more from the viewpoint of wet grip performance.

A glass transition temperature of the cap rubber layer is preferably −40° C. or higher.

When the glass transition temperature of the cap rubber layer is −40° C. or higher, a loss tangent tan δ in a temperature range higher than the Tg tends to become higher compared with a case where it is lower than −40° C., so that it is considered that effects of the present invention can be exhibited more easily.

### Definition

A “standardized rim” is a rim in a standard system including a standard, on which the tire is based, defined for each tire by the standard, i.e., a “standard rim” in JATMA, “Design Rim” in TRA, or “Measuring Rim” in ETRTO.

A “total thickness of a tread part” refers to a linear distance from an outermost surface of a tread on a tire equatorial plane to an outermost part of a band (an outermost part of a breaker if there is no band), in a case where a tire has no circumferential groove on the tire equatorial plane, or a linear distance from an outermost surface of a tread part at a central part in a tire width direction of a land part closest to the tire equatorial plane to the outermost part of the band (the outermost part of the breaker if there is no band), in a case where the tire has a circumferential groove on the tire equatorial plane, on a cross section obtained by cutting the tire along a plane including a tire rotation axis. A “land part closest to a tire equatorial plane” refers to a land part having a groove edge closest to a tire equatorial plane, of a circumferential groove present on the tire equatorial plane CL.

A “thickness of each layer of a tread part” is measured along a normal line drawn from a tire equatorial plane, in a case where a tire has no circumferential groove on the tire equatorial plane, or measured along a normal line drawn from a middle point in a tire width direction of a land part closest to the tire equatorial plane, in a case where the tire has a circumferential groove on the tire equatorial plane, on a cross section obtained by cutting the tire along a plane including a tire rotation axis.

A “plasticizer” is a material that imparts plasticity to a rubber component, which is a component extracted from a rubber composition using acetone. The plasticizer includes a liquid plasticizer (a plasticizer that is liquid (in a liquid state) at 25° C.) and a solid plasticizer (a plasticizer that is solid at 25° C.). However, it shall not comprise wax and stearic acid commonly used in the tire industry.

An “average value of acetone extraction amounts of a tread rubber” is a value obtained by calculating a value obtained by multiplying an acetone extraction amount, in % by mass, by a thickness, in %, of each rubber layer relative to a total thickness of a tread part for each rubber layer constituting the tread part, respectively, and summing these values. Specifically, it is calculated by Σ (acetone extraction amount (% by mass) of each rubber layer×thickness (%) of each rubber layer relative to total thickness of tread part/100).

An “average value of ash contents of a tread rubber” is a value obtained by calculating a value obtained by multiplying an ash content, in % by mass, by a thickness, in %, of each rubber layer relative to a total thickness of a tread part for each rubber layer constituting the tread part, respectively, and summing these values. Specifically, it is calculated by Σ (ash content (% by mass) of each rubber layer×thickness (%) of each rubber layer relative to total thickness of tread part/100).

An “oil content” also includes an amount of oil contained in the oil-extended rubber.

### Measuring Method

A “total thickness of a tread part” and a “thickness of each layer constituting a tread part” are measured in a state where a tire is cut at a plane including a tire rotation axis and a width of a bead part is adjusted to a width of a standardized rim.

An “acetone extraction amount” can be calculated by the following equation by immersing each vulcanized rubber test piece in acetone for 72 hours to extract a soluble component and measuring masses of each test piece before and after extraction in accordance with JIS K 6229:2015. When each test piece is produced by being cut out from a tire, it is cut out from a tread part of the tire so that a tire circumferential direction becomes a long side and a tire radial direction becomes a thickness direction.

(Acetone extraction amount (% by mass))={(mass of rubber test piece before extraction−mass of rubber test piece after extraction)/(mass of rubber test piece before extraction)}×100.

An “ash content in % by mass” indicates a ratio of a total mass of components that do not combust (ash contents) in a rubber composition to a total mass of the rubber composition and is determined by the following method. A vulcanized rubber test piece cut out from a tread of each test tire is placed in an alumina crucible and heated in an electric furnace at 550° C. for 4 hours to measure a mass of the vulcanized rubber test piece after heated. An “ash content in % by mass” in a rubber composition can be determined from a mass of a vulcanized rubber test piece after heated, based on 100% by mass of the vulcanized rubber test piece before heating.

A “tan δ at 30° C. (30° C. tan δ)” is a loss tangent measured using a dynamic viscoelasticity measuring device (e.g., EPLEXOR series manufactured by gabo Systemtechnik GmbH) under a condition of a temperature at 30° C., an initial strain of 5%, a dynamic strain of 1%, and a frequency of 10 Hz. A sample for measuring the loss tangent is a vulcanized rubber composition of 20 mm in length×4 mm in width×1 mm in thickness. When the sample is produced by being cut out from a tire, it is cut out from a tread part of the tire so that a tire circumferential direction becomes a long side and a tire radial direction becomes a thickness direction.

A “complex elastic modulus E* at 0° C. (0° C. E*)” is a complex elastic modulus measured using a dynamic viscoelasticity measuring device (e.g., EPLEXOR series manufactured by gabo Systemtechnik GmbH) under a condition of a temperature at 0° C., an initial strain of 10%, a dynamic strain of 2.5%, and a frequency of 10 Hz. A sample for the measurement is produced in the similar manner as in the case for the 30° C. tan δ.

A “Shore hardness” is a Shore hardness (Hs) measured under a condition of a temperature at 23° C. using a durometer type A in accordance with JIS K 6253-3:2012. A sample for measuring the Shore hardness is produced by being cut out from a tread part so that a tire radial direction becomes a thickness direction. Moreover, the measurement is performed by pressing a measuring instrument against the sample from the grounding surface side of the sample for hardness measurement.

A “rate of change in Shore hardness (Hs) of the cap rubber layer after being left to stand at 80° C. for 2 months” can be determined by leaving each test tire to stand at 80° C. for 2 months after the production and then measuring a shore hardness (Hs) of the cap rubber layer of the tread part according to the following equation:

(Rate of change in Shore hardness (%))={(Shore hardness of cap rubber layer after storage)/(acetone extraction amount of cap rubber layer after tire production)×100}−100.

A “glass transition temperature (Tg) of a rubber composition” is determined as a temperature corresponding to a largest tan δ value (tan δ peak temperature) in a temperature distribution curve of tan δ obtained by measurement, under a condition of a frequency of 10 Hz, an initial strain of 10%, an amplitude of ±0.5%, and a temperature rising rate at 2° C./min, using a dynamic viscoelasticity measuring device (e.g., EPLEXOR series manufactured by gabo Systemtechnik GmbH). A sample for the measurement is produced in the similar manner as in the case for the 30° C. tan δ.

The above-described physical property values and relational expressions of the present embodiment indicate values and relationships for a tire immediately after production or a tire that has been within one year from immediately after production and unused in mint condition.

A “styrene content” is a value calculated by ¹H-NMR measurement, and is applied to, for example, a rubber component having a repeating unit derived from styrene such as a SBR and the like. A “vinyl content (1,2-bond butadiene unit amount)” is a value calculated by infrared absorption spectrometry according to JIS K 6239-2:2017, and is applied to, for example, a rubber component having a repeating unit derived from butadiene such as a SBR, a BR, and the like. A “cis content (cis-1,4-bond butadiene unit amount)” is a value calculated by infrared absorption spectrometry according to JIS K 6239-2:2017, and is applied to, for example, a rubber component having a repeating unit derived from butadiene such as a BR and the like.

A “softening point of a resin component” can be defined as a temperature at which a sphere drops when the softening point specified in JIS K 6220-1:2001 is measured with a ring and ball softening point measuring device.

A “weight-average molecular weight (Mw)” can be calculated in terms of a standard polystyrene based on measurement values obtained by a gel permeation chromatography (GPC) (e.g., GPC-8000 Series manufactured by Tosoh Corporation, detector: differential refractometer, column: TSKGEL SUPERMULTIPORE HZ-M manufactured by Tosoh Corporation). For example, it is applied to a SBR, a BR, a plasticizer, and the like.

A “nitrogen adsorption specific surface area (N₂SA) of carbon black” is measured according to JIS K 6217-2:2017. A “nitrogen adsorption specific surface area (N₂SA) of silica” is measured by the BET method according to ASTM D3037-93.

A “glass transition point (Tg) of the plasticizer” is a value measured by differential scanning calorimetry (DSC) under a condition of a temperature rising rate of 10° C./min according to JIS K 7121:2012.

A procedure for producing a tire that is one embodiment of the present invention will be described in detail below. However, the following descriptions are illustrative for explaining the present invention, and are not intended to limit the technical scope of the present invention to this description range only.

### Tire

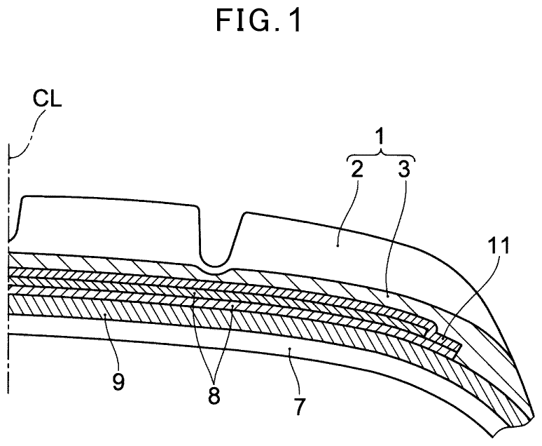

FIG. 1 is a cross-sectional view showing a part of a tread of a tire relating to the present embodiment, but the present invention is not limited to such an aspect. The tire relating to the present embodiment has a tread part 1 that touches the ground during running and a breaker 8 on the inside thereof in a tire radial direction. The breaker 8 is formed by being covered with a breaker topping rubber. A carcass 9 and an inner liner 7 are laminated on the lower part of the breaker 8. Moreover, a band may be present between the tread part 1 and the breaker 8. In FIG. 1, the breaker 8 is laminated in two layers, and a band 11 having a jointless structure is arranged inside a base rubber layer 3.

The tread part of the present embodiment has at least one rubber layer. The tread part of the present embodiment may be composed of a single rubber layer or may have two or more rubber layers, but it preferably has two or more rubber layers. A configuration of the rubber layer is not particularly limited, but it has, for example, a base rubber layer 3 adjacent to the outside of the band 11 (or the breaker 8 if there is no band) in the tire radial direction, and a cap rubber layer 2 constituting a tread surface. Moreover, one or more intermediate rubber layers may be further provided between the cap rubber layer 2 and the base rubber layer 3.

In the present embodiment, a total thickness of the tread part 1 is, but not particularly limited to, preferably 30 mm or less, more preferably 25 mm or less, further preferably 20 mm or less, particularly preferably 15 mm or less. Moreover, the total thickness of the tread is preferably 3.0 mm or more, more preferably 5.0 mm or more, further preferably 7.0 mm or more.

A thickness of the cap rubber layer 2 relative to the total thickness of the tread part 1 is 20% or more, preferably 30% or more, more preferably 40% or more, further preferably 50% or more, particularly preferably 60% or more, from the viewpoint of the effects of the present invention. On the other hand, an upper limit value of the thickness of the cap rubber layer 2 relative to the total thickness of the tread part 1 is not particularly limited, but can be, for example, 100%, 99% or less, 95% or less, or 90% or less.

A thickness of the base rubber layer 3 when present relative to the total thickness of the tread part 1 is preferably 1% or more, more preferably 5% or more, further preferably 10% or more, from the viewpoint of the effects of the present invention. On the other hand, the thickness of the base rubber layer 3 relative to the total thickness of the tread part 1 is preferably 80% or less, more preferably 70% or less, further preferably 60% or less, further preferably 50% or less, particularly preferably 40% or less.

A thickness of the intermediate rubber layer when present relative to the total thickness of the tread part 1 is not particularly limited, but can be, for example, 1% or more, 5% or more, 10% or more, 30% or less, 25% or less, or 20% or less.

### Acetone Extraction Amount

An average value of acetone extraction amounts of the tread rubber is 12.0% by mass or less, preferably 11.5% by mass or less, more preferably 11.0% by mass or less, further preferably 10.5% by mass or less, further preferably 10.0% by mass or less, particularly preferably 9.4% by mass or less, from the viewpoint of the effects of the present invention. Moreover, the average value of the acetone extraction amounts of the tread rubber is preferably 3.0% by mass or more, more preferably 4.0% by mass or more, further preferably 5.0% by mass or more, particularly preferably 6.0% by mass or more.

An acetone extraction amount of the cap rubber layer 2 is preferably 20.0% by mass or less, more preferably 18.0% by mass or less, further preferably 16.0% by mass or less, further preferably 14.0% by mass or less, further preferably 13.0% by mass or less, further preferably 12.0% by mass or less, particularly preferably 11.5% by mass or less. Moreover, the acetone extraction amount of the cap rubber layer 2 is preferably 3.0% by mass or more, more preferably 4.0% by mass or more, further preferably 5.0% by mass or more, particularly preferably 6.0% by mass or more.

An acetone extraction amount of the base rubber layer 3 when present is preferably 30.0% by mass or less, more preferably 27.0% by mass or less, further preferably 24.0% by mass or less, further preferably 21.0% by mass or less, particularly preferably 18.0% by mass or less. Moreover, the acetone extraction amount of the base rubber layer 3 is preferably 3.0% by mass or more, more preferably 4.0% by mass or more, further preferably 5.0% by mass or more, particularly preferably 6.0% by mass or more.

An acetone extraction amount of the intermediate rubber layer when present is preferably 40.0% by mass or less, more preferably 37.0% by mass or less, further preferably 34.0% by mass or less, particularly preferably 31.0% by mass or less. Moreover, the acetone extraction amount of the intermediate rubber layer is preferably 10.0% by mass or more, more preferably 13.0% by mass or more, further preferably 16.0% by mass or more, particularly preferably 19.0% by mass or more.

An acetone extraction amount of the breaker topping rubber is preferably 10.0% by mass or less, more preferably 9.0% by mass or less, further preferably 8.0% by mass or less, particularly preferably 7.0% by mass or less. Moreover, a lower limit value of the acetone extraction amount of the breaker topping rubber is not particularly limited, but is preferably 1.0% by mass or more, more preferably 2.0% by mass or more, further preferably 3.0% by mass or more, particularly preferably 4.0% by mass or more.

A difference between the average value of the acetone extraction amounts of the tread rubber and the acetone extraction amount of the breaker topping rubber is 7.0% by mass or less, preferably 6.9% by mass or less, more preferably 6.7% by mass or less, further preferably 6.5% by mass or less, further preferably 6.3% by mass or less, further preferably 6.1% by mass or more, particularly preferably 5.9% by mass or less. When the difference between the average value of the acetone extraction amounts of the tread rubber and the acetone extraction amount of the breaker topping rubber is set within the above-described ranges, a change in hardness of a rubber layer on a tread surface due to use of the tire can be appropriately controlled, and diffusion of a plasticizer from the tread rubber to the breaker topping rubber is suppressed, so that it is considered that durability of the tire can be maintained. Moreover, a lower limit value of the difference between the average value of the acetone extraction amounts of the tread rubber and the acetone extraction amount of the breaker topping rubber is not particularly limited, but is preferably 1.0% by mass or more, more preferably 2.0% by mass or more, further preferably 3.0% by mass or more, particularly preferably 4.0% by mass or more. Besides, as long as the difference is within the above-described ranges, the average value of the acetone extraction amounts of the tread rubber may be greater or less than the acetone extraction amount of the breaker topping rubber, but from the viewpoint of the effects of the present invention, the average value of the acetone extraction amounts of the tread rubber is preferably greater than the acetone extraction amount of the breaker topping rubber.

When a band is present in the tire of the present embodiment, the average value of the acetone extraction amounts of the tread rubber is preferably greater than an acetone extraction amount of the band topping rubber. Moreover, the acetone extraction amount of the band topping rubber is preferably greater than the acetone extraction amount of the breaker topping rubber.

### Ash Content

An average value of ash contents of the tread rubber is 7.5% by mass or more, preferably 8.0% by mass or more, more preferably 8.5% by mass or more, further preferably 9.0% by mass or more, further preferably 9.5% by mass or more, particularly preferably 10.0% by mass or more, from the viewpoint of suppressing migration of a plasticizer. Moreover, it is preferably 35.0% by mass or less, more preferably 30.0% by mass or less, further preferably 25.0% by mass or less, further preferably 20.0% by mass or less, further preferably 18.0% by mass or less, particularly preferably 16.0% by mass or less, from the viewpoint of rubber hardness.

An ash content of the cap rubber layer 2 is preferably 7.5% by mass or more, more preferably 8.0% by mass or more, further preferably 8.5% by mass or more, further preferably 9.0% by mass or more, further preferably 9.5% by mass or more, particularly preferably 10.0% by mass or more. Moreover, it is preferably 35.0% by mass or less, more preferably 30.0% by mass or less, further preferably 25.0% by mass or less, particularly preferably 20.0% by mass or less, from the viewpoint of rubber hardness.

An ash content of the base rubber layer 3 when present is preferably 20.0% by mass or less, more preferably 15.0% by mass or less, further preferably 10.0% by mass or less, particularly preferably 5.0% by mass or less. Moreover, a lower limit value of the ash content of the base rubber layer 3 is not particularly limited, and may be 0% by mass.

An ash content of the intermediate rubber layer when present is preferably 25.0% by mass or less, more preferably 20.0% by mass or less, further preferably 15.0% by mass or less, particularly preferably 10.0% by mass or less. Moreover, a lower limit value of the ash content of the intermediate rubber layer is not particularly limited, but can be 0% by mass, greater than 0% by mass, 1.0% by mass or more, 3.0% by mass or more, 5.0% by mass or more, or 7.0% by mass or more.

### Shore Hardness

A Shore hardness (Hs) of the cap rubber layer 2 is preferably 55 or more and 70 or less, more preferably 57 or more and 68 or less, further preferably 59 or more and 66 or less. It is considered that good steering stability and wet grip performance can be maintained by setting the Shore hardness (Hs) of the cap rubber layer 2 within the above-described ranges. Moreover, a Shore hardness (Hs) of each of the base rubber layer 3 and the intermediate rubber layer is, but not particularly limited to, preferably 55 or more and 70 or less, more preferably 57 or more and 68 or less, further preferably 59 or more and 66 or less. Besides, the Shore hardness of each of the rubber layers can be appropriately adjusted depending on types and compounding amounts of a rubber component, a filler, a plasticizer, and the like.

A rate of change in Shore hardness (Hs) of the cap rubber layer 2 after being left to stand at 80° C. for two months is preferably −10% or more and 10% or less, more preferably −8% or more and 8% or less, further preferably −6% or more and 6% or less, particularly preferably −4% or more and 4% or less. It is considered that good steering stability and wet grip performance can be maintained by setting the rate of change in Shore hardness (Hs) within the above-described ranges.

### 30° C. tan δ

30° C. tan δ of the cap rubber layer 2 is preferably 0.30 or less, more preferably 0.25 or less, further preferably 0.22 or less, particularly preferably 0.20 or less, from the viewpoint of reducing heat generation during running to suppress the first layer from hardening over time. Moreover, 30° C. tan δ of each of the base rubber layer 3 and the intermediate rubber layer is preferably 0.40 or less, more preferably 0.35 or less, further preferably 0.30 or less. On the other hand, 30° C. tan δ of each of the cap rubber layer 2, the base rubber layer 3, and the intermediate rubber layer is preferably 0.05 or more, more preferably 0.07 or more, further preferably 0.09 or more. Besides, 30° C. tan δ of each of the rubber layers can be appropriately adjusted depending on types and compounding amounts of a rubber component, a filler, a plasticizer, and the like.

### 0° C. E*

0° C. E* of the cap rubber layer 2 is preferably 4.0 MPa or more, more preferably 5.0 MPa or more, further preferably 6.0 MPa or more, further preferably 7.0 MPa or more, further preferably 9.0 MPa or more, particularly preferably 11.0 MPa or more, from the viewpoint of wet grip performance. Moreover, 0° C. E* of each of the base rubber layer 3 and the intermediate rubber layer is preferably 6.0 MPa or more, more preferably 7.0 MPa or more, from the viewpoint of wet grip performance. On the other hand, 0° C. E* of the cap rubber layer 2 is preferably 100 MPa or less, more preferably 80 MPa or less, further preferably 60 MPa or less, particularly preferably 40 MPa or less, from the viewpoint of followability to a road surface. Furthermore, a value of 0° C. E* of the cap rubber layer 2 is preferably greater than a value of 0° C. E* of each of the base rubber layer 3 and the intermediate rubber layer. Besides, 0° C. E* of each of the rubber layers can be appropriately adjusted depending on types and compounding amounts of a rubber component, a filler, a plasticizer, and the like.

### Glass Transition Temperature (Tg)

A Tg of the cap rubber layer 2 is preferably −40° C. or higher, more preferably −39° C. or higher, further preferably −38° C. or higher, from the viewpoint of wet grip performance. When the Tg is −40° C. or higher, a loss tangent tan δ in a temperature range higher than the Tg tends to become higher compared with a case of being lower than −40° C. Moreover, a Tg of each of the base rubber layer 3 and the intermediate rubber layer is preferably −60° C. or higher, more preferably −55° C. or higher, further preferably −50° C. or higher. On the other hand, an upper limit value of a Tg of each of the cap rubber layer 2, the base rubber layer 3, and the intermediate rubber layer is, but not particularly limited to, preferably 20° C. or lower, more preferably 10° C. or lower, further preferably 0° C. or lower, particularly preferably −10° C. or lower. Besides, the Tg of each of the rubber layers can be appropriately adjusted depending on types and compounding amounts of a rubber component, a filler, a plasticizer, and the like which will be described later.

### Rubber Composition for Tread

A rubber composition constituting the tread part of the present embodiment is characterized in that an average value of acetone extraction amounts thereof is within a predetermined range. The rubber composition constituting each layer of the tread part (hereinafter referred to as the rubber composition relating to the present embodiment) can be produced by using raw materials which are described below according to a required acetone extraction amount or the like. The followings are detailed descriptions.

### Rubber Component

In the rubber composition relating to the present embodiment, a diene-based rubber is appropriately used as a rubber component. Examples of the diene-based rubber include, for example, an isoprene-based rubber, a butadiene rubber (BR), a styrene-butadiene rubber (SBR), a styrene-isoprene rubber (SIR), a styrene-isoprene-butadiene rubber (SIBR), a chloroprene rubber (CR), an acrylonitrile-butadiene rubber (NBR), and the like. These rubber components may be used alone, or two or more thereof may be used in combination.

A content of the diene-based rubber in the rubber component is preferably 70% by mass or more, more preferably 80% by mass or more, further preferably 90% by mass or more, particularly preferably 95% by mass or more. Moreover, the rubber component may be one consisting of a diene-based rubber.

In the rubber composition relating to the present embodiment, at least one selected from the group consisting of an isoprene-based rubber, a styrene-butadiene rubber (SBR), and a butadiene rubber (BR) are appropriately used as rubber components. The rubber component preferably comprises an isoprene-based rubber, more preferably comprises an isoprene-based rubber and a SBR, further preferably comprises an isoprene-based rubber, a BR, and a SBR, and may be a rubber component consisting of an isoprene-based rubber, a BR, and a SBR.

### Isoprene-Based Rubber

As an isoprene-based rubber, for example, those common in the tire industry can be used, such as an isoprene rubber (IR), a natural rubber, and the like. Examples of the natural rubber include a non-reformed natural rubber (NR), as well as a reformed natural rubber such as an epoxidized natural rubber (ENR), a hydrogenated natural rubber (HNR), a deproteinized natural rubber (DPNR), an ultra pure natural rubber, a grafted natural rubber, and the like. These isoprene-based rubbers may be used alone, or two or more thereof may be used in combination.

The NR is not particularly limited, and those common in the tire industry can be used, examples of which include, for example, SIR20, RSS#3, TSR20, and the like.

A content of the isoprene-based rubber in the rubber component is preferably 80% by mass or less, more preferably 75% by mass or less, further preferably 70% by mass or less, particularly preferably 65% by mass or less, from the viewpoint of wet grip performance. Moreover, a lower limit value of the content of isoprene-based rubber is, but not particularly limited to, preferably 5% by mass or more, more preferably 10% by mass or more, further preferably 15% by mass or more, particularly preferably 20% by mass or more.

### SBR

The SBR is not particularly limited, examples of which include an unmodified solution-polymerized SBR (S-SBR) and an emulsion-polymerized SBR (E-SBR), modified SBRs (a modified S-SBR, a modified E-SBR) thereof, and the like. Examples of the modified SBR include a SBR modified at its terminal and/or main chain, a modified SBR coupled with tin, a silicon compound, etc. (a modified SBR of condensate or having a branched structure, etc.), and the like. Among them, a S-SBR and a modified SBR are preferable. Furthermore, hydrogenated ones of these SBRs (hydrogenated SBRs) and the like can also be used. These SBRs may be used alone, or two or more thereof may be used in combination.

As the SBR, an oil-extended SBR can be used, or a non-oil-extended SBR can be used. An extending oil amount of the SBR, i.e., a content of an extending oil contained in the SBR when used is preferably 10 to 50 parts by mass based on 100 parts by mass of a rubber solid content of the SBR.

As S-SBRs that can be used in the present embodiment, those commercially available from JSR Corporation, Sumitomo Chemical Co., Ltd., Ube Industries, Ltd., Asahi Kasei Corporation, ZS Elastomer Co., Ltd., etc. can be used.

A styrene content of the SBR is preferably 10% by mass or more, more preferably 15% by mass or more, further preferably 20% by mass or more, from the viewpoints of wet grip performance and abrasion resistance. Moreover, it is preferably 60% by mass or less, more preferably 55% by mass or less, further preferably 50% by mass or less, from the viewpoints of temperature dependence of grip performance and blow resistance. Besides, the styrene content of the SBR is measured by the above-described measuring method.

A vinyl content of the SBR is preferably 10 mol % or more, more preferably 15 mol % or more, further preferably 20 mol % or more, from the viewpoints of ensuring reactivity with silica, wet grip performance, rubber strength, and abrasion resistance. Moreover, the vinyl content of the SBR is preferably 80 mol % or less, more preferably 70 mol % or less, further preferably 65 mol % or less, from the viewpoints of prevention of increase in temperature dependence, elongation at break, and abrasion resistance. Besides, the vinyl content of the SBR is measured by the above-described measuring method.

A weight-average molecular weight (Mw) of the SBR is preferably 200,000 or more, more preferably 250,000 or more, further preferably 300,000 or more, from the viewpoint of wet grip performance. Moreover, the Mw of the SBR is preferably 2,000,000 or less, more preferably 1,800,000 or less, further preferably 1,500,000 or less, from the viewpoint of cross-linking uniformity. Besides, the Mw of the SBR is measured by the above-described measuring method.

A content of the SBR in the rubber component is preferably 5% by mass or more, more preferably 10% by mass or more, further preferably 15% by mass or more, particularly preferably 20% by mass or more, from the viewpoint of wet grip performance. Moreover, the content is preferably 60% by mass or less, more preferably 55% by mass or less, further preferably 50% by mass or less, particularly preferably 45% by mass or less.

### BR

The BR is not particularly limited, and those common in the tire industry can be used such as, for example, a BR having a cis content of less than 50 mol % (a low cis BR), a BR having a cis content of 90 mol % or more (a high cis BR), a rare-earth-based butadiene rubber synthesized using a rare-earth element-based catalyst (a rare-earth-based BR), a BR containing a syndiotactic polybutadiene crystal (a SPB-containing BR), a modified BR (a high cis modified BR, a low cis modified BR), and the like. Examples of the modified BR include BRs modified with similar functional groups and the like as explained in the above-described SBR. These BRs may be used alone, or two or more thereof may be used in combination.

As the high cis BR, for example, those commercially available from Zeon Corporation, Ube Industries, Ltd., JSR Corporation, etc. can be used. When the high cis BR is compounded, low temperature characteristics and abrasion resistance can be improved. The cis content of the high cis BR is preferably 95 mol % or more, more preferably 96 mol % or more, further preferably 97 mol % or more, particularly preferably 98 mol % or more.

As the rare-earth-based BR, those which are synthesized using a rare-earth element-based catalyst, and have a vinyl content of preferably 1.8 mol % or less, more preferably 1.0 mol % or less, further preferably 0.8% mol or less and a cis content of preferably 95 mol % or more, more preferably 96 mol % or more, further preferably 97 mol % or more, particularly preferably 98 mol % or more, can be used. As the rare-earth-based BR, for example, those commercially available from LANXESS, etc. can be used. Besides, the vinyl content and the cis content of the BR are measured by the above-described measuring method.

Examples of the SPB-containing BR include those in which 1,2-syndiotactic polybutadiene crystal is chemically bonded with BR and dispersed, but not those in which the crystal is simply dispersed in the BR. As such a SPB-containing BR, those commercially available from Ube Industries, Ltd., etc. can be used.

As a modified BR, a modified butadiene rubber (a modified BR) modified at its terminal and/or main chain with a functional group comprising at least one element selected from the group consisting of silicon, nitrogen, and oxygen can be appropriately used.

Examples of other modified BRs include those obtained by adding a tin compound after polymerizing 1,3-butadiene by a lithium initiator, the end of which is further bonded by tin-carbon bond (a tin-modified BR), and the like. Moreover, the modified BR may be either non-hydrogenated or hydrogenated.

The BRs listed above may be used alone, or two or more thereof may be used in combination.

A weight-average molecular weight (Mw) of the BR is preferably 300,000 or more, more preferably 350,000 or more, further preferably 400,000 or more, from the viewpoint of abrasion resistance. Moreover, it is preferably 2,000,000 or less, more preferably 1,000,000 or less, from the viewpoint of cross-linking uniformity. Besides, the Mw of the BR is measured by the above-described measuring method.

A content of the BR in the rubber component is preferably 60% by mass or less, more preferably 55% by mass or less, further preferably 50% by mass or less, particularly preferably 45% by mass or less, from the viewpoint of wet grip performance. Moreover, the content is preferably 5% by mass or more, more preferably 10% by mass or more, further preferably 15% by mass or more, particularly preferably 20% by mass or more.

### Other Rubber Components

The rubber component may comprise rubber components other than diene-based rubbers as long as they do not affect the effects of the present invention. As other rubber components other than diene-based rubbers, cross-linkable rubber components commonly used in the tire industry can be used, examples of which include, for example, a butyl rubber (IIR), a halogenated butyl rubber, an ethylene-propylene rubber, a polynorbornene rubber, a silicone rubber, a polyethylene chloride rubber, a fluorine rubber (FKM), an acrylic rubber (ACM), a hydrin rubber, and the like. These other rubber components may be used alone, or two or more thereof may be used in combination.

### Plasticizer

The rubber composition according to the present embodiment comprises a plasticizer. The plasticizer is a material that imparts plasticity to the rubber component, and has a concept that includes a liquid plasticizer (a plasticizer that is a liquid (in a liquid state) at a normal temperature (25° C.) and a solid plasticizer (a plasticizer that is a solid (in a solid state) at a normal temperature (25° C.)). Specifically, it is a component as extracted from the rubber composition using acetone. As the plasticizer, for example, oil, a resin component, a liquid polymer, an ester-based plasticizer, and the like are appropriately used. The plasticizer preferably comprises at least one selected from the group consisting of a resin component and a liquid polymer, and more preferably comprises at least one selected from the group consisting of a resin component and a liquid polymer and at least one selected from the group consisting of an oil and an ester-based plasticizer. These plasticizers may be used alone, or two or more thereof may be used in combination.

The resin component is not particularly limited, examples of which include a petroleum resin, a terpene-based resin, a rosin-based resin, a phenol-based resin, and the like, which are commonly used in the tire industry. These resin components may be used alone, or two or more thereof may be used in combination.

Examples of the petroleum resin include a C5-based petroleum resin, an aromatic petroleum resin, a C5-C9-based petroleum resin, and the like.

In the present specification, the “C5-based petroleum resin” refers to a resin obtained by polymerizing C5 fractions, and may be one obtained by hydrogenating or modifying them. Examples of the C5 fraction include, for example, a petroleum fraction having 4 to 5 carbon atoms such as cyclopentadiene, a pentene, a pentadiene, isoprene, and the like. As the C5-based petroleum resin, a dicyclopentadiene resin (DCPD resin) is appropriately used.

In the present specification, an “aromatic petroleum resin” refers to a resin obtained by polymerizing C9 fractions, and may be one obtained by hydrogenating or modifying them. Examples of the C9 fraction include, for example, a petroleum fraction having 8 to 10 carbon atoms such as vinyltoluene, alkylstyrene, indene, methylindene, and the like. As specific examples of the aromatic petroleum resin, for example, a coumarone indene resin, a coumarone resin, an indene resin, and an aromatic vinyl-based resin are appropriately used. As the aromatic vinyl-based resin, a homopolymer of α-methylstyrene or styrene or a copolymer of α-methylstyrene and styrene is preferable, and a copolymer of α-methylstyrene and styrene is more preferable, because it is economical, easy to process, and excellent in heat generation. As the aromatic vinyl-based resin, for example, those commercially available from Kraton Corporation, Eastman Chemical Company, etc. can be used.

In the present specification, the “C5-C9-based petroleum resin” refers to a resin obtained by copolymerizing the C5 fraction and the C9 fraction, and may be one obtained by hydrogenating or modifying them. Examples of the C5 fraction and the C9 fraction include the above-described petroleum fractions. As the C5-C9-based petroleum resin, for example, those commercially available from Tosoh Corporation, Luhua Co., Ltd, etc. can be appropriately used.

Examples of the terpene-based resin include a polyterpene resin consisting of at least one selected from terpene compounds such as α-pinene, β-pinene, limonene, a dipentene, and the like; an aromatic-modified terpene resin made from the above-described terpene compounds and an aromatic compound; a terpene phenolic resin made from the above-described terpene compounds and a phenol-based compound; and those in which these terpene-based resins are hydrogenated (hydrogenated terpene-based resins). Examples of the aromatic compound used as a raw material for the aromatic-modified terpene resin include, for example, styrene, α-methylstyrene, vinyltoluene, a divinyltoluene, and the like. Examples of the phenol-based compound used as a raw material for the terpene phenolic resin include, for example, phenol, bisphenol A, cresol, xylenol, and the like.

Example of the rosin-based resin include, but not particularly limited to, for example, a natural resin rosin and a rosin-modified resin obtained by modifying it by hydrogenation, disproportionation, dimerization, esterification, or the like.

Examples of the phenol-based resin include, but not particularly limited to, a phenol formaldehyde resin, an alkylphenol formaldehyde resin, an alkylphenol acetylene resin, an oil-modified phenol formaldehyde resin, and the like.

A content of the resin component when compounded based on 100 parts by mass of the rubber component is preferably 1 part by mass or more, more preferably 3 parts by mass or more, further preferably 5 parts by mass or more, particularly preferably 7 parts by mass or more. Moreover, the content of the resin component is preferably 50 parts by mass or less, more preferably 40 parts by mass or less, further preferably 30 parts by mass or less, particularly preferably 20 parts by mass or less.

The liquid polymer is not particularly limited as long as it is a polymer in a liquid state at a normal temperature (25° C.), examples of which include, for example, a liquid butadiene rubber (a liquid BR), a liquid styrene-butadiene rubber (a liquid SBR), a liquid isoprene rubber (a liquid IR), a liquid styrene-isoprene rubber (a liquid SIR), a liquid farnesene rubber, and the like. These liquid polymers may be used alone, or two or more thereof may be used in combination.

A content of the liquid polymer when compounded based on 100 parts by mass of the rubber component is preferably 1 part by mass or more, more preferably 3 parts by mass or more, further preferably 5 parts by mass or more, particularly preferably 7 parts by mass or more. Moreover, the content of the liquid polymer is preferably 50 parts by mass or less, more preferably 40 parts by mass or less, further preferably 30 parts by mass or less, particularly preferably 20 parts by mass or less.

The resin component and the liquid polymer relating to the present embodiment preferably exhibit fluidity at 130° C. or higher, which is a processing temperature of a rubber, from the viewpoint of processability. From this, the resin component and the liquid polymer preferably have a glass transition point of 100° C. or lower and a softening point of 120° C. or lower.

The softening point of the resin component is preferably 60° C. or higher, more preferably 65° C. or higher, further preferably 70° C. or higher, from the viewpoint of wet grip performance. Moreover, it is preferably 115° C. or lower, more preferably 110° C. or lower, further preferably 105° C. or lower, from the viewpoints of processability and improvement in dispersibility of a rubber component with a filler.

The glass transition point (Tg) of the liquid polymer is preferably −90° C. or higher, more preferably −85° C. or higher. Moreover, the Tg of the liquid polymer is preferably 20° C. or lower, more preferably 10° C. or lower, further preferably 0° C. or lower, particularly preferably −10° C. or lower.

A weight-average molecular weight (Mw) of each of the resin component and the liquid polymer relating to the present embodiment is preferably 800 or more, preferably 1000 or more, more preferably 2000 or more, further preferably 3000 or more, particularly preferably 3500 or more, from the viewpoint of suppressing hardening of a rubber layer on a tread surface over time. Moreover, the Mw of the liquid polymer is preferably 30,000 or less, more preferably 10,000 or less, further preferably 8,000 or less, particularly preferably 6,000 or less.

Examples of oil include, for example, a process oil, vegetable fats and oils, animal fats and oils, and the like. Examples of the process oil include a paraffin-based process oil, a naphthene-based process oil, an aroma-based process oil, and the like. Moreover, as an environmental measure, a process oil having a low content of a polycyclic aromatic compound (PCA) can also be used. Examples of the process oil having a low content of a PCA include a mild extraction solvent (MES), a treated distillate aromatic extract (TDAE), a heavy naphthenic oil, and the like.

A content of oil when compounded based on 100 parts by mass of the rubber component is preferably 1 part by mass or more, more preferably 2 parts by mass or more, further preferably 3 parts by mass or more. Moreover, the content of oil is preferably 50 parts by mass or less, more preferably 40 parts by mass or less, further preferably 30 parts by mass or less, particularly preferably 20 parts by mass or less.

Examples of the ester-based plasticizer include, for example, dibutyl adipate (DBA), diisobutyl adipate (DIBA), dioctyl adipate (DOA), bis(2-ethylhexyl) azelate (DOZ), dibutyl sebacate (DBS), diisononyl adipate (DINA), diethyl phthalate (DEP), dioctyl phthalate (DOP), diundecyl phthalate (DUP), dibutyl phthalate (DBP), dioctyl sebacate (DOS), tributyl phosphate (TBP), trioctyl phosphate (TOP), triethyl phosphate (TEP), trimethyl phosphate (TMP), thymidine triphosphate (TTP), tricresyl phosphate (TCP), trixylenyl phosphate (TXP), and the like. These ester-based plasticizers may be used alone, or two or more thereof may be used in combination.

A content of the ester-based plasticizer when compounded based on 100 parts by mass of the rubber component is preferably 1 part by mass or more, more preferably 2 parts by mass or more, further preferably 3 parts by mass or more. Moreover, the content of the ester-based plasticizer is preferably 50 parts by mass or less, more preferably 40 parts by mass or less, further preferably 30 parts by mass or less, particularly preferably 20 parts by mass or less.

A total content of the resin component and the liquid polymer based on 100 parts by mass of the rubber component of the rubber composition constituting the cap rubber layer 2 is preferably 2 parts by mass or more, more preferably 4 parts by mass or more, further preferably 6 parts by mass or more, particularly preferably 8 parts by mass or more, from the viewpoint of adjusting a speed at which a plasticizer migrates to an adjacent rubber layer. Moreover, it is preferably 50 parts by mass or less, more preferably 40 parts by mass or less, further preferably 30 parts by mass or less, particularly preferably 20 parts by mass or less, from the viewpoint of the effects of the present invention.

A total content of the oil and the ester-based plasticizer based on 100 parts by mass of the rubber component of the rubber composition constituting the cap rubber layer 2 is preferably 1 part by mass or more, more preferably 2 parts by mass or more, further preferably 3 parts by mass or more, from the viewpoint of adjusting a speed at which a plasticizer migrates to an adjacent rubber layer. Moreover, it is preferably 40 parts by mass or less, more preferably 30 parts by mass or less, further preferably 25 parts by mass or less, further preferably 20 parts by mass or less, further preferably 17 parts by mass or less, particularly preferably 14 parts by mass or less, from the viewpoint of suppressing a plasticizer from migrating to an adjacent rubber layer at an early stage to cause a rubber to harden.

A mass content ratio of the resin component and the liquid polymer to the oil and the ester-based plasticizer in the rubber composition constituting the cap rubber layer 2 is preferably 0.5 or more, more preferably 0.7 or more, further preferably 1.1 or more, further preferably 1.5 or more, further preferably 2.0 or more, further preferably 2.5 or more, particularly preferably 3.0 or more. Moreover, the mass content ratio of the resin component and the liquid polymer to the oil and the ester-based plasticizer in the rubber composition constituting the cap rubber layer 2 is preferably 20 or less, more preferably 15 or less, further preferably 12 or less, further preferably 10 or less, further preferably 9.5 or less, particularly preferably 9.0 or less. When the mass content ratio of the resin component and the liquid polymer to the oil and the ester-based plasticizer in the rubber composition constituting the cap rubber layer 2 is set within the above-described ranges, a plasticizer can be suppressed from migrating to an adjacent rubber layer at an early stage to cause a rubber to harden.

A total content of plasticizers based on 100 parts by mass of the rubber component of the rubber composition constituting the cap rubber layer 2 is preferably 5 parts by mass or more, more preferably 7 parts by mass or more, further preferably 9 parts by mass or more, particularly preferably 11 parts by mass or more, from the viewpoint of the effects of the present invention. Moreover, the total content of plasticizers is preferably 100 parts by mass or less, more preferably 80 parts by mass or less, further preferably 60 parts by mass or less, particularly preferably 40 parts by mass or less.

A total content of the oil and the ester-based plasticizer based on 100 parts by mass of the rubber component of the rubber composition constituting the base rubber layer 3 and the intermediate rubber layer is preferably 3 parts by mass or more, more preferably 5 parts by mass or more, further preferably 7 parts by mass or more. Moreover, the total content of the oil and the ester-based plasticizer based on 100 parts by mass of the rubber component of the rubber composition constituting the base rubber layer 3 is preferably 100 parts by mass or less, more preferably 80 parts by mass or less, further preferably 60 parts by mass or less. A content of the resin component and the liquid polymer based on 100 parts by mass of the rubber component of the rubber composition constituting the base rubber layer 3 and the intermediate rubber layer is, but not particularly limited to, preferably 10 parts by mass or less, more preferably 5 parts by mass or less, further preferably 3 parts by mass or less, particularly preferably 2 parts by mass or less.

### Filler

For the rubber composition relating to the present embodiment, a filler comprising carbon black and/or silica is appropriately used. The rubber composition constituting the cap rubber layer 2 and the intermediate layer more preferably comprise silica as a filler, and more preferably comprise carbon black and silica. The rubber composition constituting the base rubber layer 3 preferably comprises carbon black as a filler.

### Carbon Black

As carbon black, those common in the tire industry can be appropriately used, examples of which include, for example, GPF, FEF, HAF, ISAF, SAF, and the like. These carbon black may be used alone, or two or more thereof may be used in combination.

A nitrogen adsorption specific surface area (N₂SA) of carbon black is preferably 10 m²/g or more, more preferably 20 m²/g or more, further preferably 35 m²/g or more, particularly preferably 50 m²/g or more, from the viewpoint of reinforcing property. Moreover, it is preferably 200 m²/g or less, more preferably 150 m²/g or less, further preferably 100 m²/g or less, particularly preferably 80 m²/g or less, from the viewpoints of fuel efficiency and processability. Besides, the N₂SA of carbon black is measured by the above-described measuring method.

A content of carbon black based on 100 parts by mass of the rubber component is preferably 20 parts by mass or more, more preferably 25 parts by mass or more, further preferably 30 parts by mass or more, particularly preferably 35 parts by mass or more, from the viewpoints of abrasion resistance and wet grip performance. Moreover, it is preferably 80 parts by mass or less, more preferably 75 parts by mass or less, further preferably 70 parts by mass or less, particularly preferably 65 parts by mass or less, from the viewpoint of fuel efficiency.

### Silica

Silica is not particularly limited, and those common in the tire industry can be used, such as, for example, silica prepared by a dry process (anhydrous silica), silica prepared by a wet process (hydrous silica), and the like. Among them, hydrous silica prepared by a wet process is preferable from the reason that it has many silanol groups. These silica may be used alone, or two or more thereof may be used in combination.

A nitrogen adsorption specific surface area (N₂SA) of silica is preferably 140 m²/g or more, more preferably 150 m²/g or more, further preferably 160 m²/g or more, particularly preferably 170 m²/g or more, from the viewpoints of fuel efficiency and abrasion resistance. Moreover, it is preferably 350 m²/g or less, more preferably 300 m²/g or less, further preferably 250 m²/g or less, from the viewpoints of fuel efficiency and processability. Besides, the N₂SA of silica is measured by the above-described measuring method.

A content of silica when compounded in the rubber composition constituting the cap rubber layer 2 and the intermediate layer based on 100 parts by mass of the rubber component is preferably 10 parts by mass or more, more preferably 15 parts by mass or more, further preferably 20 parts by mass or more, particularly preferably 25 parts by mass or more, from the viewpoint of an ash content. Moreover, it is preferably 90 parts by mass or less, more preferably 80 parts by mass or less, further preferably 70 parts by mass or less, particularly preferably 60 parts by mass or less, from the viewpoint of rubber hardness.

A content of silica when compounded in the rubber composition constituting the base rubber layer 3 based on 100 parts by mass of the rubber component is, but not particularly limited to, preferably 20 parts by mass or less, more preferably 10 parts by mass or less, further preferably 5 parts by mass or less, or may be 0 part by mass or less.

A total content of silica and carbon black based on 100 parts by mass of the rubber component is preferably 30 parts by mass or more, more preferably 35 parts by mass or more, further preferably 40 parts by mass or more, particularly preferably 45 parts by mass or more, from the viewpoint of abrasion resistance. Moreover, it is preferably 120 parts by mass or less, more preferably 100 parts by mass or less, further preferably 90 parts by mass or less, particularly preferably 80 parts by mass or less, from the viewpoints of fuel efficiency and elongation at break.

In the rubber composition constituting the cap rubber layer 2, a content of carbon black based on 100 parts by mass of the rubber component is preferably greater than a content of silica from the viewpoint of a balance of steering stability and wet grip performance. A ratio of a content of carbon black to a total content of silica and carbon black in the rubber composition constituting the cap rubber layer 2 is preferably 51% by mass or more, more preferably 54% by mass or more, further preferably 57% by mass or more, particularly preferably 60% by mass or more. Moreover, the ratio of the content of carbon black to the total content of silica and carbon black in the rubber composition constituting the cap rubber layer 2 is preferably 90% by mass or less, more preferably 85% by mass or less, further preferably 80% by mass or less, particularly preferably 75% by mass or less.

### Silane Coupling Agent

Silica is preferably used in combination with a silane coupling agent. The silane coupling agent is not particularly limited, and any silane coupling agent conventionally used in combination with silica in the tire industry can be used, examples of which include, for example, mercapto-based silane coupling agents such as 3-mercaptopropyltrimethoxysilane, 3-mercaptopropyltriethoxysilane, 2-mercaptoethyltrimethoxysilane, 2-mercaptoethyltriethoxysilane, and the like; sulfide-based silane coupling agents such as bis(3-triethoxysilylpropyl)disulfide, bis(3-triethoxysilylpropyl)tetrasulfide, and the like; thioester-based silane coupling agents such as 3-octanoylthio-1-propyltriethoxysilane, 3-hexanoylthio-1-propyltriethoxysilane, 3-octanoylthio-1-propyltrimethoxysilane, and the like; vinyl-based silane coupling agents such as vinyltriethoxysilane, vinyltrimethoxysilane, and the like; amino-based silane coupling agents such as 3-aminopropyltriethoxysilane, 3-aminopropyltrimethoxysilane, 3-(2-aminoethyl)aminopropyltriethoxysilane, and the like; glycydoxy-based silane coupling agents such as γ-glycidoxypropyltriethoxysilane, γ-glycidoxypropyltrimethoxysilane, and the like; nitro-based silane coupling agents such as 3-nitropropyltrimethoxysilane, 3-nitropropyltriethoxysilane, and the like; chloro-based silane coupling agents such as 3-chloropropyltrimethoxysilane, 3-chloropropyltriethoxysilane, and the like; and the like. Among them, sulfide-based silane coupling agents and/or mercapto-based silane coupling agents are preferably compounded. As the silane coupling agent, for example, those commercially available from Momentive Performance Materials, etc. can be used. These silane coupling agents may be used alone, or two or more thereof may be used in combination.

A total content of silane coupling agents when compounded based on 100 parts by mass of the rubber component is preferably 0.5 parts by mass or more, more preferably 1.0 part by mass or more, further preferably 2.0 parts by mass or more, particularly preferably 3.0 parts by mass or more, from the viewpoint of enhancing dispersibility of silica. Moreover, it is preferably 20 parts by mass or less, more preferably 15 parts by mass or less, further preferably 12 parts by mass or less, particularly preferably 9.0 parts by mass or less, from the viewpoint of preventing deterioration of abrasion resistance.

A content of the silane coupling agent based on 100 parts by mass of silica is preferably 1.0 part by mass or more, more preferably 3.0 parts by mass or more, further preferably 5.0 parts by mass or more, from the viewpoint of enhancing dispersibility of silica. Moreover, it is preferably 20 parts by mass or less, more preferably 15 parts by mass or less, further preferably 12 parts by mass or less, from the viewpoints of cost and processability.

As fillers, other fillers may further be used in addition to carbon black and silica. Such filler is not particularly limited, and any filler commonly used in this field such as, for example, aluminum hydroxide, alumina (aluminum oxide), calcium carbonate, magnesium sulfate, talc, clay, and the like can be used. These other fillers may be used alone, or two or more thereof may be used in combination.

### Other Compounding Agents

The rubber composition according to the present embodiment can appropriately comprise compounding agents conventionally and generally used in the tire industry, for example, wax, processing aid, stearic acid, zinc oxide, an antioxidant, a vulcanizing agent, a vulcanization accelerator, and the like, in addition to the above-described components.

A content of wax when compounded based on 100 parts by mass of the rubber component is preferably 0.5 parts by mass or more, more preferably 1 part by mass or more, from the viewpoint of weather resistance of a rubber. Moreover, it is preferably 10 parts by mass or less, more preferably 5 parts by mass or less, from the viewpoint of preventing whitening of a tire due to bloom.

Examples of processing aid include, for example, a fatty acid metal salt, a fatty acid amide, an amide ester, a silica surface active agent, a fatty acid ester, a mixture of a fatty acid metal salt and an amide ester, a mixture of a fatty acid metal salt and a fatty acid amide, and the like. These processing aid may be used alone, or two or more thereof may be used in combination. As processing aid, for example, those commercially available from Schill+Seilacher GmbH, Performance Additives, etc. can be used.

A content of processing aid when compounded based on 100 parts by mass of the rubber component is preferably 0.5 parts by mass or more, more preferably 1 part by mass or more, from the viewpoint of exhibiting an effect of improving processability. Moreover, it is preferably 10 parts by mass or less, more preferably 8 parts by mass or less, from the viewpoints of abrasion resistance and breaking strength.

Examples of the antioxidant include, but not particularly limited to, for example, amine-based, quinoline-based, quinone-based, phenol-based and imidazole-based compounds, a carbamic acid metal salt, and the like, preferably, phenylenediamine-based antioxidants such as N-(1,3-dimethylbutyl)-N′-phenyl-p-phenylenediamine, N-isopropyl-N′-phenyl-p-phenylenediamine, N,N′-diphenyl-p-phenylenediamine, N,N′-di-2-naphthyl-p-phenylenediamine, N-cyclohexyl-N′-phenyl-p-phenylenediamine, and the like, and quinoline-based antioxidants such as 2,2,4-trimethyl-1,2-dihydroquinoline polymer, 6-ethoxy-2,2,4-trimethyl-1,2-dihydroquinoline, and the like. These antioxidants may be used alone, or two or more thereof may be used in combination.

A content of the antioxidant when compounded based on 100 parts by mass of the rubber component is preferably 0.5 parts by mass or more, more preferably 1 part by mass or more, from the viewpoint of ozone crack resistance of a rubber. Moreover, it is preferably 10 parts by mass or less, more preferably 5 parts by mass or less, from the viewpoints of abrasion resistance and wet grip performance.

A content of stearic acid when compounded based on 100 parts by mass of the rubber component is preferably 0.5 parts by mass or more, more preferably 1 part by mass or more, from the viewpoint of processability. Moreover, it is preferably 10 parts by mass or less, more preferably 5 parts by mass or less, from the viewpoint of vulcanization rate.

A content of zinc oxide when compounded based on 100 parts by mass of the rubber component is preferably 0.5 parts by mass or more, more preferably 1 part by mass or more, from the viewpoint of processability. Moreover, it is preferably 10 parts by mass or less, more preferably 5 parts by mass or less, from the viewpoint of abrasion resistance.

Sulfur is appropriately used as a vulcanizing agent. As sulfur, a powdery sulfur, an oil processing sulfur, a precipitated sulfur, a colloidal sulfur, an insoluble sulfur, a highly dispersible sulfur, and the like can be used.

A content of sulfur when compounded as a vulcanizing agent based on 100 parts by mass of the rubber component is preferably 0.1 parts by mass or more, more preferably 0.3 parts by mass or more, further preferably 0.5 parts by mass or more, from the viewpoint of securing a sufficient vulcanization reaction. Moreover, it is preferably 5.0 parts by mass or less, more preferably 4.0 parts by mass or less, further preferably 3.0 parts by mass or less, from the viewpoint of preventing deterioration. Besides, a content of the vulcanizing agent when an oil-containing sulfur is used as the vulcanizing agent shall be a total content of pure sulfur comprised in the oil-containing sulfur.

Examples of vulcanizing agents other than sulfur include, for example, an alkylphenol-sulfur chloride condensate, sodium hexamethylene-1,6-bisthiosulfate dihydrate, 1,6-bis(N,N′-dibenzylthiocarbamoyldithio)hexane, and the like. As these vulcanizing agents other than sulfur, those commercially available from Taoka Chemical Co., Ltd., LANXESS, Flexsys, etc. can be used.

Examples of the vulcanization accelerator include, for example, sulfenamide-based, thiazole-based, thiuram-based, thiourea-based, guanidine-based, dithiocarbamic acid-based, aldehyde-amine-based or aldehyde-ammonia-based, imidazoline-based, and xantate-based vulcanization accelerators, and the like. These vulcanization accelerators may be used alone, or two or more thereof may be used in combination. Among them, one or more vulcanization accelerators selected from the group consisting of sulfenamide-based, guanidine-based, and thiazole-based vulcanization accelerators are preferable, and sulfenamide-based vulcanization accelerators are more preferable.

Examples of the sulfenamide-based vulcanization accelerator include, for example, N-tert-butyl-2-benzothiazolylsulfenamide (TBBS), N-cyclohexyl-2-benzothiazolylsulfenamide (CBS), N,N-dicyclohexyl-2-benzothiazolylsulfenamide (DCBS), and the like. Among them, N-cyclohexyl-2-benzothiazolylsulfenamide (CBS) is preferable.

A content of the vulcanization accelerator when compounded based on 100 parts by mass of the rubber component (a total amount of all of a plurality of vulcanization accelerators when used in combination) is preferably 1 part by mass or more, more preferably 2 parts by mass or more, further preferably 3 parts by mass or more. Moreover, the content of the vulcanization accelerator based on 100 parts by mass of the rubber component is preferably 8 parts by mass or less, more preferably 7 parts by mass or less, further preferably 6 parts by mass or less. When the content of the vulcanization accelerator is within the above-described ranges, breaking strength and elongation tend to be secured.

The rubber composition relating to the present embodiment can be produced by a known method. For example, it can be produced by kneading each of the above-described components using a rubber kneading apparatus such as an open roll, a closed type kneader (Bunbury mixer, kneader, etc.), and the like.

The kneading step includes, for example, a base kneading step of kneading compounding agents and additives other than vulcanizing agents and vulcanization accelerators and a final kneading (F kneading) step of adding vulcanizing agents and vulcanization accelerators to the kneaded product obtained by the base kneading step and kneading them. Furthermore, the base kneading step can be divided into a plurality of steps, if desired.

A kneading condition is not particularly limited. Examples of kneading include, for example, in the base kneading step, a method of kneading at a discharge temperature of 150 to 170° C. for 3 to 10 minutes, and in the final kneading step, a method of kneading at 70 to 110° C. for 1 to 5 minutes. A vulcanization condition is not particularly limited. Examples of vulcanization include, for example, a method of vulcanizing at 150 to 200° C. for 10 to 30 minutes.

The tire relating to the present embodiment can be produced by a usual method using the above-described rubber composition. That is, the tire can be produced by extruding an unvulcanized rubber composition, obtained by compounding each of the above-described components based on the rubber component as necessary, into a shape of each rubber layer of a tread part with an extruder equipped with a mouthpiece having a predetermined shape, attaching it together with other tire members on a tire forming machine, and molding them by a usual method to form an unvulcanized tire, followed by heating and pressurizing this unvulcanized tire in a vulcanizing machine.

### Application

The tire relating to the present embodiment can be appropriately used as a tire for a passenger car, a tire for a truck/bus, a motorcycle tire, or a racing tire. Among them, it is preferably used as a tire for a passenger car. Besides, the tire for a passenger car is a tire on the premise that it is mounted on a car running on four wheels and refers to one having a maximum load capacity of 1000 kg or less. Moreover, the tire relating to the present embodiment can be used as an all-season tire, a summer tire, or a winter tire such as a studless tire and the like.

### EXAMPLE

Although the present invention will be described based on Examples, it is not limited to Examples.

Various chemicals used in Examples and Comparative examples are collectively shown below.
NR: TSR20
SBR: SBR produced according to Production example 1 below (styrene content: 25% by mass, vinyl content: 59 mol %, Mw: 250,000, non-oil extended)
BR: Ubepol BR (Registered Trademark) 150B manufactured by Ube Industries, Ltd. (vinyl content: 1.5 mol %, cis content: 97 mol %, Mw: 440,000)
Carbon black: Seast 6 manufactured by Tokai Carbon Co., Ltd. (DBP oil absorption amount: 114 mL/100 g, N₂SA: 119 m²/g)
Silica: Zeosil 1115MP manufactured by Solvay (N₂SA: 160 m²/g)
Silane coupling agent: Si75 manufactured by Evonik Degussa GmbH (bis(3-triethoxysilylpropyl)disulfide)
Oil 1: Process X-140 manufactured by ENEOS Corporation (aroma-based process oil, Tg: −41° C., Mw: 600)
Oil 2: PS-32 manufactured by Idemitsu Kosan Co., Ltd. (paraffin-based process oil)
Liquid polymer 1: Kuraprene LIR-50 manufactured by Kuraray Co., Ltd. (liquid IR, Tg: −63° C.)
Liquid polymer 2: Kuraprene LBR-302 manufactured by Kuraray Co., Ltd. (liquid BR, Tg: −85° C.)
Liquid polymer 3: Liquid SBR produced according to Production example 2 below (Tg: −25° C., Mw: 5000)
Resin component 1: Sylvatraxx 4401 manufactured by Kraton Corporation (copolymer of α-methylstyrene and styrene, softening point: 85° C.)
Resin component 2: PX1150N manufactured by Yasuhara Chemical Co., Ltd. (non-hydrogenated polyterpene resin, softening point: 115° C., Tg: 65° C.)
Resin component 3: MARCARETS M M-890A manufactured by Maruzen Petrochemical Co., Ltd. (dicyclopentadiene resin, softening point: 105° C.)
Antioxidant 1: Nocrac 6C manufactured by Ouchi Shinko Chemical Industry Co., Ltd. (N-(1,3-dimethylbutyl)-N′-phenyl-p-phenylenediamine)
Antioxidant 2: Nocrac RD manufactured by Ouchi Shinko Chemical Industry Co., Ltd. (poly(2,2,4-trimethyl-1,2-dihydroquinoline))
Zinc oxide: Zinc oxide No. 1 manufactured by Mitsui Mining & Smelting Co., Ltd.
Stearic acid: Bead stearic acid “CAMELLIA” manufactured by NOF CORPORATION
Sulfur: Powdered sulfur manufactured by Karuizawa Sulfur Co, Ltd.
Vulcanization accelerator: Nocceler CZ manufactured by Ouchi Shinko Chemical Industry Co., Ltd. (N-cyclohexyl-2-benzothiazolsulfenamide)

### Production Example 1: Production of SBR

600 mL of hexane, 75 g of 1,3-butadiene, 25 g of styrene, and 60 mL of tetrahydrofuran were charged into an autoclave reactor subjected to nitrogen purge and stirred at 40° C. After adding 0.1 mol/L of n-butyllithium/hexane solution in 0.5 mL each to scavenge them, 4 mL of 0.1 mol/L n-butyllithium/hexane solution was added, and the mixture was stirred at a stirring speed of 130 rpm and a jacket temperature at 80° C. After confirming production of a polymer having a Mw of 250,000 by GPC, a polymerization solution was poured into 4 L of ethanol to collect a precipitate. After blow-drying the obtained precipitate, it was dried under reduced pressure at 80° C./10 Pa or lower until a drying loss became 0.1% to obtain a SBR.

### Production Example 2: Production of Liquid Polymer 3

After adding 20 mL of a 1.0 mol/L n-butyllithium/hexane solution, 200 ml of hexane, and 60 mL of tetrahydrofuran to an autoclave reactor subjected to nitrogen purge, the mixture was stirred at a stirring speed of 80 rpm and a jacket temperature at 80° C. while adding a monomer solution in which 75 g of 1,3-butadiene and 25 g of styrene were dissolved in 400 ml of hexane so that the temperature of the reaction solution did not exceed 90° C. After confirming production of a polymer having a Mw of 5000 by GPC, a polymerization solution was poured into 4 L of ethanol to collect a precipitate. After blow-drying the obtained precipitate, it was dried under reduced pressure at 80° C./10 Pa or lower until a drying loss became 0.1%. As a result of analyzing the obtained liquid by DSC, a Tg was −25° C.

### Examples and Comparative Examples

According to the compounding formulations shown in Table 1, using a 1.7 L closed Banbury mixer, all chemicals other than sulfur and vulcanization accelerators were kneaded until reaching a discharge temperature at 150° C. to 160° C. for 1 to 10 minutes to obtain a kneaded product. Next, using a twin-screw open roll, sulfur and vulcanization accelerators were added to the obtained kneaded product, and the mixture was kneaded for 4 minutes until the temperature reached 105° C. to obtain an unvulcanized rubber composition. The obtained unvulcanized rubber composition was molded into each shape of the cap rubber layer, the intermediate rubber layer, and the base rubber layer of the tread part, and attached together with other tire members, preparing an unvulcanized tire, followed by vulcanized at 170° C. to obtain each test tire described in Table 2 (size: 165/65R15, rim: 15×5J, internal pressure: 230 kPa). Besides, a total thickness of the tread part was set to be 10 mm.

### Measurement of Acetone Extraction Amount (AE Amount)

An AE amount was measured for each of the vulcanized rubber test pieces. The AE amount was calculated by the following equation by immersing each vulcanized rubber test piece in acetone for 24 hours to extract a soluble component and measuring a mass of each test piece before and after extraction:

Acetone extraction amount (%)={(mass of vulcanized rubber test piece before extraction−mass of vulcanized rubber test piece after extraction)/(mass of rubber test piece before extraction)}×100.

### Measurement of Ash Content

A test piece cut out from a tread of each test tire was placed in an alumina crucible and heated in an electric furnace at 550° C. for 4 hours. Then, an ash content (% by mass) was calculated by (mass of test piece after heating/mass of test piece before heating)×100.

### Measurement of 30° C. tan δ

For each vulcanized rubber test piece produced by being cut out with 20 mm in length×4 mm in width×1 mm in thickness from inside of a rubber layer of a tread part of each test tire so that a tire circumferential direction became on a long side, using the dynamic viscoelasticity measuring device (EPLEXOR series manufactured by gabo Systemtechnik GmbH), a loss tangent tan δ was measured under a condition of a temperature at 30° C., an initial strain of 5%, a dynamic strain of 1%, and a frequency of 10 Hz. Besides, a thickness direction of a sample was defined as a tire radial direction.

### Measurement of 0° C. E*

For each vulcanized rubber test piece produced by being cut out with 20 mm in length×4 mm in width×1 mm in thickness from inside of a rubber layer of a tread part of each test tire so that a tire circumferential direction became on a long side, using the dynamic viscoelasticity measuring device (EPLEXOR series manufactured by gabo Systemtechnik GmbH), a complex elastic modulus E* was measured under a condition of a temperature at 0° C., an initial strain of 10%, a dynamic strain of 2.5%, and a frequency of 10 Hz. Besides, a thickness direction of a sample was defined as a tire radial direction.

### Measurement of Glass Transition Temperature (Tg)

For each unvulcanized rubber test piece produced by being cut out with 20 mm in length×4 mm in width×1 mm in thickness from inside of a rubber layer of a tread part of each test tire so that a tire circumferential direction becomes on a long side, a temperature distribution curve of a loss tangent tan δ was measured under a condition of a frequency of 10 Hz, an initial strain of 10%, an amplitude of ±0.5%, and a temperature rising rate of 2° C./min, using the dynamic viscoelasticity measuring device (EPLEXOR series manufactured by gabo Systemtechnik GmbH), and a temperature corresponding to the largest tan δ value in the obtained temperature distribution curve (tan δ peak temperature) was defined as a glass transition temperature (Tg). Besides, a thickness direction of a sample was defined as a tire radial direction.

### Measurement of Rubber Hardness (Hs)

A shore hardness (Hs) of each rubber test piece at a temperature of 23° C. was measured using a durometer type A in accordance with JIS K6253-3:2012. Besides, as each rubber test piece, a rubber test piece cut out from inside of the rubber layer of the tread part of each test tire was used.

### Hardness After Storage

A shore hardness (Hs) of the cap rubber layer of the tread part was measured after leaving each test tire to stand at 80° C. for 2 months after production. A rate of change (%) in Shore hardness of the cap rubber layer was calculated by the following equation:

(Rate of change in Shore hardness (%))={(Shore hardness of cap rubber layer after storage)/(acetone extraction amount of cap rubber layer after tire production)×100}−100.

### Hardness After Running

Each test tire was mounted on four wheels of an FF passenger vehicle with a displacement of 2000 cc, respectively, and after the vehicle was made run 20000 km in an urban area, a Shore hardness (Hs) of the cap rubber layer of the tread part was measured.

### Steering Stability

Each test tire was mounted on four wheels of an FF passenger vehicle with a displacement of 2000 cc, and actual vehicle running was performed on a test course with a dry asphalt road surface. Handling characteristics was evaluated based on each feeling of straight running, changing lanes, and accelerating/decelerating during running by a test driver at 100 km/h. The evaluation was performed using an integer value of 1 to 10 points to calculate a total score by 10 test drivers based on evaluation criteria that the higher the score is, the better the handling characteristics is. A total score of a control tire (Comparative example 2) in mint condition was converted into a reference value (100), and the evaluation result for each test tire was indicated as an index in proportion to the total score.

### Wet Grip Performance After Abrasion

After thermally deteriorating the above-described tire at 80° C. for 7 days, a tread part was worn along a tread radius so that a thickness of the tread part became 50% of that in mint condition. Each test tire was mounted on all wheels of a vehicle (domestic FF2000 cc), and a braking distance from a point where a brake was applied at a speed of 100 km/h on a wet asphalt road surface was measured. An inverse value of a braking distance of each test tire was indicated as an index according to the following equation, with calculation of a braking distance of the control tire (Comparative example 1) being as 100. The results show that the higher the index is, the more the wet grip performance after abrasion is maintained.

(Wet grip performance index)=(braking distance of control tire)/(braking distance of each test tire).

### Durability

Each test tire was made run on a drum for 30,000 km at 60 km/h under a condition of an internal pressure of 200 kPa and a load (standardized load) using a drum testing machine. Then, tires that have run the whole distance without breaking were rated as “+”, and tires in which separation has occurred in a breaker layer were rated as “−”.

TABLE 1

| | Cap rubber layer | | | | | | |
|---|---|---|---|---|---|---|---|
| | A | J | K | M | N | O | P |
| Compounding amount (part by mass) | | | | | | | |
| NR | 30 | 30 | 30 | 30 | 30 | 30 | 30 |
| SBR | 30 | 30 | 30 | 30 | 30 | 30 | 30 |
| BR | 40 | 40 | 40 | 40 | 40 | 40 | 40 |
| Carbon black | 50 | 50 | 50 | 50 | 50 | 50 | 50 |
| Silica | 30 | 30 | 30 | 30 | 30 | 30 | 30 |
| Silane coupling agent | 2.4 | 2.4 | 2.4 | 2.4 | 2.4 | 2.4 | 2.4 |
| Oil 1 | 27 | 17 | 12 | 3.0 | 2.0 | 2.0 | 2.0 |
| Oil 2 | — | — | — | — | — | — | — |
| Liquid polymer 1 | — | 12 | 15 | — | — | — | — |
| Liquid polymer 2 | — | — | — | 15 | — | — | — |
| Liquid polymer 3 | — | — | — | — | 15 | — | — |
| Resin component 1 | — | — | — | — | — | 8.0 | — |
| Resin component 2 | — | — | — | — | — | — | 17 |
| Resin component 3 | — | — | — | — | — | — | — |
| Antioxidant 1 | 2.0 | 2.0 | 2.0 | 2.0 | 2.0 | 2.0 | 2.0 |
| Antioxidant 2 | 2.0 | 2.0 | 2.0 | 2.0 | 2.0 | 2.0 | 2.0 |
| Zinc oxide | 3.0 | 3.0 | 3.0 | 3.0 | 3.0 | 3.0 | 3.0 |
| Stearic acid | 2.0 | 2.0 | 2.0 | 2.0 | 2.0 | 2.0 | 2.0 |
| Sulfur | 1.5 | 1.5 | 1.5 | 1.5 | 1.5 | 1.5 | 1.5 |
| Vulcanization accelerator | 1.5 | 1.5 | 1.5 | 1.5 | 1.5 | 1.5 | 1.5 |
| Physical property | | | | | | | |
| Acetone extraction amount (% by mass) | 15.8 | 11.1 | 9.0 | 9.0 | 10.7 | 8.8 | 8.6 |
| Ash content (% by mass) | 13.6 | 13.4 | 13.6 | 14.1 | 14.2 | 14.7 | 14.1 |
| Shore hardness (Hs) | 60 | 60 | 62 | 62 | 62 | 63 | 63 |
| 30° C. tan δ | 0.18 | 0.19 | 0.19 | 0.18 | 0.19 | 0.16 | 0.15 |
| 0° C. E* (MPa) | 14 | 26 | 30 | 17 | 21 | 25 | 22 |
| Tg (° C.) | −36 | −36 | −38 | −39 | −37 | −35 | −32 |

| | | | | Intermediate | Base rubber | |
|---|---|---|---|---|---|---|
| | Cap rubber layer | | | rubber layer | layer | |
| | Q | R | S | C | F | L |
| Compounding amount (part by mass) | | | | | | |
| NR | 30 | 60 | 60 | 30 | 80 | 80 |
| SBR | 30 | 40 | 40 | 20 | 20 | 20 |
| BR | 40 | — | — | 50 | — | — |
| Carbon black | 50 | 70 | 40 | 60 | 60 | 50 |
| Silica | 30 | — | 30 | 20 | — | — |
| Silane coupling agent | 2.4 | — | 2.4 | 1.6 | — | — |
| Oil 1 | 2.0 | — | — | 50 | 27 | 7.0 |
| Oil 2 | — | — | 16 | — | — | — |
| Liquid polymer 1 | — | — | — | — | — | 5.0 |
| Liquid polymer 2 | — | — | — | — | — | — |
| Liquid polymer 3 | — | — | — | — | — | — |
| Resin component 1 | — | — | — | — | — | — |
| Resin component 2 | — | — | — | — | — | — |
| Resin component 3 | 10 | — | — | — | — | — |
| Antioxidant 1 | 2.0 | 2.0 | 2.0 | 2.0 | 2.0 | 2.0 |
| Antioxidant 2 | 2.0 | 2.0 | 2.0 | 2.0 | 2.0 | 2.0 |
| Zinc oxide | 3.0 | 3.0 | 3.0 | 3.0 | 3.0 | 3.0 |
| Stearic acid | 2.0 | 2.0 | 2.0 | 2.0 | 2.0 | 2.0 |
| Sulfur | 1.5 | 1.5 | 1.5 | 3.5 | 2.5 | 2.0 |
| Vulcanization accelerator | 1.5 | 1.5 | 1.5 | 2.0 | 1.8 | 1.5 |
| Physical property | | | | | | |
| Acetone extraction amount (% by mass) | 8.7 | 4.3 | 11.4 | 23.4 | 16.4 | 7.2 |
| Ash content (% by mass) | 14.5 | 0 | 14.7 | 8.1 | 0 | 0 |
| Shore hardness (Hs) | 63 | 60 | 65 | 55 | 65 | 65 |
| 30° C. tan δ | 0.18 | 0.19 | 0.19 | 0.16 | 0.24 | 0.20 |
| 0° C. E* (MPa) | 23 | 34 | 29 | 11 | 12 | 12 |
| Tg (° C.) | −38 | −39 | −39 | −38 | −36 | −39 |

TABLE 2

| | Example | | | | | | | | | | |
|---|---|---|---|---|---|---|---|---|---|---|---|
| | 1 | 2 | 3 | 4 | 5 | 6 | 7 | 8 | 9 | 10 | 11 |
| Compounding of cap | J | J | K | M | N | O | P | Q | S | O | O |
| rubber layer | | | | | | | | | | | |
| Compounding of | — | — | — | — | — | — | — | — | — | C | — |
| intermediate rubber layer | | | | | | | | | | | |
| Compounding of | F | L | F | F | F | F | F | F | F | F | L |
| base rubber layer | | | | | | | | | | | |
| Thickness (%) | | | | | | | | | | | |
| Cap rubber layer | 90 | 70 | 90 | 90 | 90 | 90 | 90 | 90 | 90 | 80 | 30 |
| Intermediate rubber layer | — | — | — | — | — | — | — | — | — | 10 | — |
| Base rubber layer | 10 | 30 | 10 | 10 | 10 | 10 | 10 | 10 | 10 | 10 | 70 |
| Acetone extraction amount | | | | | | | | | | | |
| (% by mass) | | | | | | | | | | | |
| Cap rubber layer | 11.1 | 11.1 | 9.0 | 9.0 | 10.7 | 8.8 | 8.6 | 8.7 | 11.4 | 8.8 | 8.8 |
| Intermediate rubber layer | — | — | — | — | — | — | — | — | — | 23.4 | — |
| Base rubber layer | 16.4 | 7.2 | 16.4 | 16.4 | 16.4 | 16.4 | 16.4 | 16.4 | 16.4 | 16.4 | 7.2 |
| (A) Tread rubber | 11.6 | 9.9 | 9.7 | 9.7 | 11.3 | 9.6 | 9.4 | 9.5 | 11.9 | 11.0 | 7.7 |
| (B) Breaker rubber | 5.0 | 5.0 | 5.0 | 5.0 | 5.0 | 5.0 | 5.0 | 5.0 | 5.0 | 5.0 | 5.0 |
| (A) − (B) | 6.6 | 4.9 | 4.7 | 4.7 | 6.3 | 4.6 | 4.4 | .4.5 | 6.9 | 6.4 | 2.7 |
| Ash content (% by mass) | | | | | | | | | | | |
| Cap rubber layer | 13.4 | 13.4 | 13.6 | 14.1 | 14.2 | 14.7 | 14.1 | 14.5 | 14.7 | 14.7 | 14.7 |
| Intermediate rubber layer | — | — | — | — | — | — | — | — | — | 8.1 | — |
| Base rubber layer | 0 | 0 | 0 | 0 | 0 | 0 | 0 | 0 | 0 | 0 | 0 |
| Tread rubber | 12.1 | 9.4 | 12.2 | 12.7 | 12.8 | 13.2 | 12.7 | 13.1 | 13.2 | 12.6 | 13.2 |
| Shore hardness (Hs) | | | | | | | | | | | |
| Cap rubber layer | 60 | 60 | 62 | 62 | 62 | 63 | 63 | 63 | 65 | 63 | 63 |
| Intermediate rubber layer | — | — | — | — | — | — | — | — | — | 55 | — |
| Base rubber layer | 65 | 65 | 65 | 65 | 65 | 65 | 65 | 65 | 65 | 65 | 65 |
| 30° C. tan δ | | | | | | | | | | | |
| Cap rubber layer | 0.19 | 0.19 | 0.19 | 0.18 | 0.19 | 0.16 | 0.15 | 0.18 | 0.19 | 0.16 | 0.16 |
| Intermediate rubber layer | — | — | — | — | — | — | — | — | — | 0.16 | — |
| Base rubber layer | 0.24 | 0.20 | 0.24 | 0.24 | 0.24 | 0.24 | 0.24 | 0.24 | 0.24 | 0.24 | 0.20 |
| 0° C. E* (MPa) | | | | | | | | | | | |
| Cap rubber layer | 26 | 26 | 30 | 17 | 21 | 25 | 22 | 23 | 29 | 25 | 25 |
| Intermediate rubber layer | — | — | — | — | — | — | — | — | — | 11 | — |
| Base rubber layer | 12 | 12 | 12 | 12 | 12 | 12 | 12 | 12 | 12 | 12 | 12 |
| Tg (° C.) | | | | | | | | | | | |
| Cap rubber layer | −36 | −36 | −38 | −39 | −37 | −35 | −32 | −38 | −39 | −35 | −35 |
| Intermediate rubber layer | — | — | — | — | — | — | — | — | — | −38 | — |
| Base rubber layer | −36 | −39 | −36 | −36 | −36 | −36 | −36 | −36 | −36 | −36 | −39 |
| Shore hardness (Hs) of cap | 61 | 61 | 62 | 63 | 62 | 65 | 65 | 65 | 65 | 61 | 64 |
| rubber layer after storage | | | | | | | | | | | |
| Rate of change in hardness (%) | 1.7 | 1.7 | 0 | 1.6 | 0 | 3.2 | 3.2 | 3.2 | 0 | −3.2 | 1.6 |
| Shore hardness (Hs) of cap | 61 | 61 | 61 | 61 | 61 | 61 | 61 | 61 | 61 | 60 | 63 |
| rubber layer after running | | | | | | | | | | | |
| Index | | | | | | | | | | | |
| Steering stability | 104 | 103 | 103 | 103 | 103 | 104 | 105 | 104 | 106 | 105 | 104 |
| Wet grip performance | 103 | 104 | 103 | 104 | 107 | 106 | 105 | 104 | 102 | 105 | 103 |
| Durability | + | + | + | + | + | + | + | + | + | + | + |

| | Comparative example | | | | |
|---|---|---|---|---|---|
| | 1 | 2 | 3 | 4 | 5 |
| Compounding of cap rubber layer | A | J | J | J | R |
| Compounding of intermediate rubber layer | — | — | — | C | — |
| Compounding of base rubber layer | F | F | L | F | F |
| Thickness (%) | | | | | |
| Cap rubber layer | 90 | 90 | 50 | 80 | 90 |
| Intermediate rubber layer | — | — | — | 10 | — |
| Base rubber layer | 10 | 10 | 50 | 10 | 10 |
| Acetone extraction amount (% by mass) | | | | | |
| Cap rubber layer | 15.8 | 11.1 | 11.1 | 11.1 | 4.3 |
| Intermediate rubber layer | — | — | — | 23.4 | — |
| Base rubber layer | 16.4 | 16.4 | 7.2 | 16.4 | 16.4 |
| (A) Tread rubber | 15.9 | 11.6 | 9.2 | 12.9 | 5.5 |
| (B) Breaker rubber | 5.0 | 4.0 | 5.0 | 6.0 | 5.0 |
| (A) − (B) | 10.9 | 7.6 | 4.2 | 6.9 | 0.5 |
| Ash content (% by mass) | | | | | |
| Cap rubber layer | 13.6 | 13.4 | 13.4 | 13.4 | 0 |
| Intermediate rubber layer | — | — | — | 8.1 | — |
| Base rubber layer | 0 | 0 | 0 | 0 | 0 |
| Tread rubber | 12.2 | 12.1 | 6.7 | 11.5 | 0 |
| Shore hardness (Hs) | | | | | |
| Cap rubber layer | 60 | 60 | 60 | 60 | 60 |
| Intermediate rubber layer | — | — | — | 55 | — |
| Base rubber layer | 65 | 65 | 65 | 65 | 65 |
| 30° C. tan δ | | | | | |
| Cap rubber layer | 0.18 | 0.19 | 0.19 | 0.19 | 0.19 |
| Intermediate rubber layer | — | — | — | 0.16 | — |
| Base rubber layer | 0.24 | 0.24 | 0.20 | 0.24 | 0.24 |
| 0° C. E* (MPa) | | | | | |
| Cap rubber layer | 14 | 26 | 26 | 26 | 34 |
| Intermediate rubber layer | — | — | — | 11 | — |
| Base rubber layer | 12 | 12 | 12 | 12 | 12 |
| Tg (° C.) | | | | | |
| Cap rubber layer | −36 | −36 | −36 | −36 | −39 |
| Intermediate rubber layer | — | — | — | — | — |
| Base rubber layer | −36 | −36 | −39 | −36 | −36 |
| Shore hardness (Hs) of cap rubber | 66 | 67 | 68 | 67 | 66 |
| layer after storage | | | | | |
| Rate of change in hardness (%) | 10.0 | 11.7 | 13.3 | 11.7 | 10.0 |
| Shore hardness (Hs) of cap rubber | 66 | 62 | 68 | 67 | 66 |
| layer after running | | | | | |
| Index | | | | | |
| Steering stability | 98 | 100 | 94 | 94 | 89 |
| Wet grip performance | 99 | 100 | 93 | 92 | 97 |
| Durability | − | + | + | + | + |

From the results in Tables 1 and 2, it can be found that the tire of the present invention suppresses the hardening phenomenon of the tread part over time and improves in steering stability and wet grip performance. Moreover, it can be found that durability also improves in a preferred embodiment.

### Embodiments

Examples of embodiments of the present invention will be shown below.
[1] A tire comprising a tread part having at least one rubber layer and a breaker, wherein a thickness of a cap rubber layer constituting a tread surface relative to a total thickness of the tread part is 20% or more (preferably 30% or more, more preferably 40% or more, further preferably 50% or more, particularly preferably 60% or more), wherein an average value of acetone extraction amounts of a tread rubber constituting the tread part is 12.0% by mass or less (preferably 11.5% by mass or less, more preferably 11.0% by mass or less, further preferably 10.5% by mass or less, further preferably 10.0% by mass or less, particularly preferably 9.4% by mass or less), wherein a difference between the average value of the acetone extraction amounts of the tread rubber and an acetone extraction amount of a breaker topping rubber is 7.0% by mass or less (preferably 6.9% by mass or less, more preferably 6.5% by mass or less, further preferably 5.9% by mass or less), and wherein an average value of ash contents of the tread rubber is 7.5% by mass or more (preferably 8.0% by mass or more, more preferably 8.5% by mass or more, further preferably 9.0% by mass or more, further preferably 9.5% by mass or more, particularly preferably 10.0% by mass or more).
[2] The tire of [1] above, wherein a rate of change in Shore hardness (Hs) of the cap rubber layer after being left to stand at 80° C. for two months is −10% or more and 10% or less (preferably −8% or more and 8% or less, more preferably −6% or more and 6% or less, further preferably −4% or more and 4% or less).
[3] The tire of [1] or [2] above, wherein a Shore hardness (Hs) of the cap rubber layer is 55 or more and 70 or less (preferably 57 or more and 68 or less, more preferably 59 or more and 66 or less).
[4] The tire of any one of [1] to [3] above, wherein a rubber component constituting the cap rubber layer comprises at least one selected from the group consisting of an isoprene-based rubber, a styrene-butadiene rubber, and a butadiene rubber (preferably an isoprene-based rubber, more preferably an isoprene-based rubber and a styrene-butadiene rubber, further preferably an isoprene-based rubber, a butadiene rubber, and a styrene-butadiene rubber).
[5] The tire of any one of [1] to [4] above, wherein a rubber composition constituting the cap rubber layer contains 5 parts by mass or more and 100 parts by mass or less (preferably 7 parts by mass or more and 80 parts by mass or less, more preferably 9 parts by mass or more and 60 parts by mass or less, further preferably 11 parts or more and 40 parts by mass or less) of a plasticizer based on 100 parts by mass of the rubber component.
[6] The tire of any one of [1] to [5] above, wherein the rubber composition constituting the cap rubber layer comprises at least one selected from the group consisting of a resin component and a liquid polymer.
[7] The tire of any one of [1] to [6] above, wherein a mass content ratio of the resin component and the liquid polymer to oil and an ester-based plasticizer in the rubber composition constituting the cap rubber layer is 0.5 or more and 20 or less (preferably 1.1 or more and 12 or less, more preferably 2.5 or more and 9.5 or less).
[8] The tire of any one of [1] to [7] above, wherein a tan δ of the cap rubber layer at 30° C. is 0.30 or less (preferably 0.25 or less, more preferably 0.22 or less, further preferably 0.20 or less).
[9] The tire of any one of [1] to [8] above, wherein 0° C. E* of the cap rubber layer is 5.0 MPa or more (preferably 6.0 MPa or more, more preferably 7.0 MPa or more, further preferably 9.0 MPa or more, particularly preferably 11.0 MPa or more).
[10] The tire of any one of [1] to [9] above, wherein a glass transition temperature of the cap rubber layer is −40° C. or higher (preferably −39° C. or higher, more preferably −38° C. or higher).
[11] The tire of any one of [1] to [10], wherein the tire is a tire for a passenger car.

### REFERENCE SIGNS LIST

1. Tread part
2. Cap rubber layer
3. Base rubber layer
7. Inner liner
8. Breaker
9. Carcass
11. Band
CL. Tire equatorial plane

1. A tire comprising a tread part having at least one rubber layer and a breaker,
wherein a thickness of a cap rubber layer constituting a tread surface relative to a total thickness of the tread part is 20% or more,
wherein an average value of acetone extraction amounts of a tread rubber constituting the tread part is 12.0% by mass or less,
wherein a difference between the average value of the acetone extraction amounts of the tread rubber and an acetone extraction amount of a breaker topping rubber is 7.0% by mass or less, and
wherein an average value of ash contents of the tread rubber is 7.5% by mass or more.

2. The tire of claim 1, wherein a rate of change in Shore hardness (Hs) of the cap rubber layer after being left to stand at 80° C. for two months is −10% or more and 10% or less.

3. The tire of claim 1 or 2, wherein a Shore hardness (Hs) of the cap rubber layer is 55 or more and 70 or less.

4. The tire of any one of claims 1 to 3, wherein a rubber component constituting the cap rubber layer comprises at least one selected from the group consisting of an isoprene-based rubber, a styrene-butadiene rubber, and a butadiene rubber.

5. The tire of any one of claims 1 to 4, wherein a rubber composition constituting the cap rubber layer contains 5 parts by mass or more and 100 parts by mass or less of a plasticizer based on 100 parts by mass of the rubber component.

6. The tire of any one of claims 1 to 5, wherein the rubber composition constituting the cap rubber layer comprises at least one selected from the group consisting of a resin component and a liquid polymer.

7. The tire of any one of claims 1 to 6, wherein a mass content ratio of the resin component and the liquid polymer to oil and an ester-based plasticizer in the rubber composition constituting the cap rubber layer is 0.5 or more and 20 or less.

8. The tire of any one of claims 1 to 7, wherein a tan δ of the cap rubber layer at 30° C. is 0.30 or less.

9. The tire of any one of claims 1 to 8, wherein 0° C. E* of the cap rubber layer is 5.0 MPa or more.

10. The tire of any one of claims 1 to 9, wherein a glass transition temperature of the cap rubber layer is −40° C. or higher.

11. The tire of any one of claims 1 to 10, wherein the tire is a tire for a passenger car.
